(19) United States
(12) Patent Application Publication
(10) Pub. No.: US 2025/0336933 A1
(43) Pub. Date: Oct. 30, 2025

(54) ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Chang Won PARK, Suwon-si (KR); Ho Sung YANG, Suwon-si (KR); Duck Jae YOU, Suwon-si (KR); Ji Ye WOO, Suwon-si (KR)

(73) Assignee: SAMSUNG SDI CO., LTD., Yongin-si (KR)

(21) Appl. No.: 19/193,573

(22) Filed: Apr. 29, 2025

(30) Foreign Application Priority Data
Apr. 30, 2024 (KR) 10-2024-0057507

(51) Int. Cl. H01M 4/36; H01M 4/02; H01M 4/62; H01M 10/0525

(52) U.S. Cl. CPC H01M 4/364; H01M 4/366; H01M 4/62; H01M 10/0525; H01M 2004/027

(57) ABSTRACT

The present disclosure relates to an electrode for a rechargeable lithium battery, and a rechargeable lithium battery including the electrode. The electrode includes an active material layer for a rechargeable lithium battery, and an organic-inorganic composite layer integrated with the active material layer. The organic-inorganic composite layer includes nanofibers, the nanofibers include an inorganic material and a matrix, the inorganic material includes one or more of boron nitride nanosheets and boron nitride nanotubes, the matrix includes one or more of a polyimide-based polymer and a polyamic acid-based polymer, and the inorganic material is included in an amount of about 0.1 wt % to about 7 wt % in the nanofibers.

### CROSS-REFERENCE TO RELATED APPLICATION

The present application claims the benefit of priority to Korean Patent Application No. 10-2024-0057507, filed on Apr. 30, 2024 in the Korean Intellectual Property Office, the entire disclosure of which being incorporated herein by reference.

### BACKGROUND

### 1. Field of the Disclosure

The present disclosure relates to an electrode for a rechargeable lithium battery, and a rechargeable lithium battery including the electrode.

### 2. Discussion of Related Art

With increasing presence of electronic devices that use batteries, such as, e.g., mobile phones, laptop computers, electric vehicles, and the like, the demand for rechargeable batteries with high energy density and high capacity has increased. Accordingly, improving the performance of rechargeable lithium batteries may be advantageous.

A rechargeable lithium battery includes a positive electrode and a negative electrode, which include an active material capable of intercalation and deintercalation of lithium ions, and an electrolyte, and produces electrical energy through oxidation and reduction reactions when lithium ions are intercalated to and deintercalated from the positive electrode and the negative electrode.

### SUMMARY

An example embodiment of the present disclosure includes an electrode for a rechargeable lithium battery, which includes an organic-inorganic composite layer integrated with an active material layer. The organic-inorganic composite layer has a desired or improved puncture strength, a low heat shrinkage rate, a desired or improved dispersibility of an inorganic material in nanofibers, and a desired or improved adhesion to the active material layer.

Another example embodiment of the present disclosure includes a rechargeable lithium battery including the electrode for a rechargeable lithium battery.

An aspect of the present includes an electrode for a rechargeable lithium battery.

The electrode for a rechargeable lithium battery includes an active material layer for a rechargeable lithium battery, and an organic-inorganic composite layer integrated with the active material layer for a rechargeable lithium battery. The organic-inorganic composite layer includes nanofibers, the nanofibers include an inorganic material and a matrix, the inorganic material includes one or more of boron nitride nanosheets and boron nitride nanotubes, the matrix includes one or more of a polyimide (PI)-based polymer and a polyamic acid (PAA)-based polymer, and the inorganic material is included in an amount of about 0.1 wt % to about 7 wt % in the nanofibers.

Another example aspect of the present disclosure includes a rechargeable lithium battery.

The rechargeable lithium battery includes the electrode for a rechargeable lithium battery and an electrode for a rechargeable lithium battery facing the electrode for a rechargeable lithium battery.

In the electrode for a rechargeable lithium battery according to an example embodiment of the present disclosure, because an organic-inorganic composite layer, which may replace conventional separators, is integrated with an active material layer, there may be no need to perform a lamination process to combine the separator and the active material layer, and thus it is possible to economically manufacture batteries.

In the electrode for a rechargeable lithium battery according to an example embodiment, the organic-inorganic composite layer is a single layer and may replace the conventional multilayer of organic and inorganic layers, making it possible to simply and economically manufacture batteries.

In the electrode for a rechargeable lithium battery according to an example embodiment, the organic-inorganic composite layer has a desired or improved puncture strength, a low heat shrinkage rate, a desired or improved adhesion to the active material layer, and a desired or improved dispersibility of inorganic materials in the nanofibers, thereby increasing the stability and lifetime of the rechargeable lithium battery.

### BRIEF DESCRIPTION OF THE DRAWINGS

The above and other objects, features and advantages of the present disclosure are more apparent to those of ordinary skill in the art by describing example embodiments thereof in detail with reference to the accompanying drawings, in which:

FIG. 1 is a cross-sectional view of an electrode for a rechargeable lithium battery, according to an example embodiment of the present disclosure; and

FIGS. 2 to 5 are cross-sectional views schematically illustrating a rechargeable lithium battery, according to an example embodiment of the present disclosure.

### DETAILED DESCRIPTION

Hereinafter, example embodiments of the present disclosure are described in detail. However, the embodiments are presented as an example, the present disclosure is not limited thereby, and the present disclosure is only defined by the scope of the claims described below.

Unless otherwise specified herein, when a part such as a layer, a membrane, a region, a plate, and the like is said to be “on” another part, it includes not only the case where it is “directly on” another part, but also the case where another part is present therebetween.

Unless otherwise specified herein, the singular may also include the plural. In addition, unless otherwise specified, “A or B” may indicate “including A,” “including B,” or “including A and B.”

As included herein, a “combination thereof” may indicate a mixture, a laminate, a composite, a copolymer, an alloy, a blend, a reaction product of components.

Unless otherwise defined herein, the particle size may be an average particle size. In addition, the particle size refers to the average particle size (D50), which is the diameter of particles with a cumulative volume of 50 vol % in the particle size distribution. The average particle size (D50) may be measured by a known method to those skilled in the art, for example, using a particle size analyzer, a transmission electron micrograph, or a scanning electron micrograph. As another method, the average particle size may be measured using a measurement device using dynamic light scattering, and an average particle diameter D50 value may be obtained by performing data analysis, counting the number of particles in each particle size range, and then calculating the D50 value therefrom. Alternatively, the average particle size may be measured using a laser diffraction method. When measuring the average particle diameter by the laser diffraction method, for example, the average particle size (D50) may be calculated by dispersing the target particles in a dispersion medium, introducing the particles into a commercially available laser diffraction particle size measuring device (such as MT 3000 from Microtrac), and irradiating the particles with ultrasonic waves of about 28 kHz at an output of 60 W to measure the average particle size (D50) based on 50% of the particle size distribution.

When the terms “about” or “substantially” are used in this specification in connection with a numerical value, it is intended that the associated numerical value include a tolerance of =10% around the stated numerical value. When ranges are specified, the range includes all values therebetween such as increments of 0.1%.

The electrode for a rechargeable lithium battery (hereinafter may be referred to as “electrode”) according to an example embodiment of the present disclosure includes an active material layer for a rechargeable lithium battery, and an organic-inorganic composite layer integrated with the active material layer. The organic-inorganic composite layer includes nanofibers, the nanofibers include an inorganic material and a matrix, the inorganic material includes one or more of boron nitride nanosheets and boron nitride nanotubes, the matrix includes one or more of a polyimide (PI)-based polymer and a polyamic acid (PAA)-based polymer, and the inorganic material is included in an amount of about 0.1 wt % to about 7 wt % in the nanofibers.

### Organic-Inorganic Composite Layer:

The organic-inorganic composite layer is located between the electrode for a rechargeable lithium battery and an electrode facing the electrode for a rechargeable lithium battery, and may be configured as a separator to reduce or prevent short circuits.

The rechargeable lithium battery including the electrode according to an example embodiment of the present disclosure may not include a separator. Thus, the electrode may not require a lamination process to combine the separator and the electrode when manufacturing batteries such as, e.g., a stack cell, making it possible to manufacture batteries in a simple and economical process.

The organic-inorganic composite layer is integrated with the active material layer for a rechargeable lithium battery. The “integration” indicates that the organic-inorganic composite layer is formed directly on the active material layer without any intervening layer therebetween, and refers to the state in which the organic-inorganic composite layer is more firmly bonded to the active material layer. The integration may reduce or prevent an increase in resistance when lithium ions move.

According to an example embodiment of the present disclosure, the organic-inorganic composite layer may be integrated with the active material layer by permeating into the active material layer and being dried.

Through scanning electron microscopy (SEM) or transmission electron microscopy (TEM) images, it can be confirmed that the active material layer and the organic-inorganic composite layer are integrated. According to an example embodiment, in the SEM or TEM images, the active material layer and the organic-inorganic composite layer are distinguished from each other, but the integration can be confirmed in that the interface (boundary portion) between the active material layer and the organic-inorganic composite layer is not clearly distinguished and is uneven (e.g., not flat).

The organic-inorganic composite layer may be a single layer. Herein, the “single layer” may indicate that the organic-inorganic composite layer is composed of a single layer compared to the conventional organic-inorganic composite layer composed of multiple layers including an organic layer and an inorganic layer. The organic-inorganic composite layer may replace multiple layers including an organic layer and an inorganic layer, and thus it is possible to manufacture batteries in a simple and economical process. According to an example embodiment of the present disclosure, the electrode may not include an inorganic layer. Herein, “inorganic layer” may refer to a layer, which includes an inorganic component or an inorganic material such as, e.g., a ceramic, or a layer, which includes an inorganic component or an inorganic material as a main component (for example, including 70 wt % or more of an inorganic component or inorganic material).

According to an example embodiment of the present disclosure, the organic-inorganic composite layer may have a thickness ranging from about 1 μm to about 20 μm, for example, from 1 μm to 10 μm. In this specification, the “thickness of the organic-inorganic composite layer” refers to the thickness of the region where an organic component is present in a layered form in the organic-inorganic composite layer, and does not indicate the thickness of the region where an organic component is present independently or separately. When the thickness of the organic-inorganic composite layer is within the above range, a high density may be achieved.

The organic-inorganic composite layer includes nanofibers. According to an example embodiment of the present disclosure, the organic-inorganic composite layer includes a plurality of nanofibers, and the organic-inorganic composite layer may include some of the nanofibers in a woven or non-woven state, for example, a network structure. The organic-inorganic composite layer with a network structure may minimize resistance when lithium ions move. The organic-inorganic composite layer in the woven state may refer to a porous layer with pores formed between nanofibers. For example, when the organic-inorganic composite layer is formed as a dense layer, the movement distance of lithium ions increases and the resistance during the movement of lithium ions relatively increases, which may not be desired. According to an example embodiment of the present disclosure, the diameter of the pore may be in a range of about 90 nm or less, for example, 10 nm to 90 nm.

According to an example embodiment, the average diameter of the nanofibers may be in a range of about 300 nm or less, for example, 10 nm to 200 nm, 10 nm to 100 nm, 50 nm to 100 nm. Within the above range, the organic-inorganic composite layer may be readily formed.

The nanofiber includes an inorganic material, and the inorganic material includes one or more of boron nitride nanosheets and boron nitride nanotubes.

One or more of the boron nitride nanosheets and boron nitride nanotubes may readily increase the puncture strength of the organic-inorganic composite layer, and simultaneously or contemporaneously lower the heat shrinkage rate of the organic-inorganic composite layer.

One or more of the boron nitride nanosheets and boron nitride nanotubes are included in an amount in a range of about 0.1 wt % to about 7 wt % in the nanofibers. When one or more of the boron nitride nanosheets and boron nitride nanotubes are included in an amount in a range of about 0.1 wt % or more, puncture strength may be increased and the heat shrinkage rate may be reduced compared to a layer including nanofibers composed of a matrix alone, which is described below. When one or more of the boron nitride nanosheets and boron nitride nanotubes are included in an amount in a range of about 7 wt % or less, electrospinning, which is described below, is performed efficiently, making it possible to form an organic-inorganic composite layer, and the boron nitride nanosheets and boron nitride nanotubes are not exposed to the outside of the nanofibers, making it possible to reduce resistance when lithium ions move. For example, one or more of the boron nitride nanosheets and boron nitride nanotubes may be included in an amount in a range of about 1 wt % to about 7 wt %, or about 3 wt % to about 7 wt % in the nanofibers.

According to an example embodiment of the present disclosure, one or more of the boron nitride nanosheets and boron nitride nanotubes may be included in an amount in a range of about 95 wt % or more, for example, 99 wt % to 100 wt %, 100 wt % in the inorganic material. Within the above content range, sufficient puncture strength and a low heat shrinkage rate may be obtained.

In examples, the boron nitride nanosheets have a hexagonal structure similar to graphite by combining boron and nitrogen at a molar ratio of about 1:1, and boron nitride has a two-dimensional crystal structure.

According to an example embodiment of the present disclosure, the boron nitride nanosheets may have a thickness ranging from about 0.3 nm to about 30 nm, for example, from 3 nm to 10 nm, and may have a maximum diameter ranging from about 10 nm to about 200 nm, for example, from 10 nm to 100 nm. According to an example embodiment of the present disclosure, the boron nitride nanosheets have an upper surface, a lower surface, and a side connecting the upper and lower surfaces, and one or more of the upper and lower surfaces may have a polygonal shape, such as a rectangle or square, or a curved surface such as a circle. According to an example embodiment of the present disclosure, the ratio of the maximum diameter to the thickness of the boron nitride nanosheets may range from about 10 to about 300, for example, from 10 to 50.

The boron nitride nanotubes have a tubular structure similar to carbon nanotubes by combining boron and nitrogen at a molar ratio of about 1:1. According to an example embodiment, the boron nitride nanotubes may have an average outer diameter in a range of about 10 nm to about 100 nm, for example, 10 nm to 50 nm, an average length in a range of about 1 μm to about 50 μm, for example, 10 μm to 50 μm, and an aspect ratio of about 10 to about 5000, for example, 100 to 3000. The “aspect ratio” is the ratio of the average length to the average outer diameter of the boron nitride nanotubes.

For example, the inorganic material may include boron nitride nanosheets. The boron nitride nanosheets may have higher puncture strength and dispersibility when included in nanofibers at the same content as boron nitride nanotubes.

The boron nitride nanosheets and boron nitride nanotubes may readily increase the puncture strength of the organic-inorganic composite layer and reduce the heat shrinkage rate of the organic-inorganic composite layer, but due to their specific shapes described above, the dispersibility of the nanofibers in the matrix may be reduced during the electrospinning process. In order to increase the dispersibility of boron nitride nanosheets and boron nitride nanotubes, dispersion methods, such as applying ultrasonic waves to an electrospinning solution including boron nitride nanosheets and boron nitride nanotubes, may be used, but applying these additional dispersion methods may reduce processability when the organic-inorganic composite layer is manufactured. In addition, because the organic-inorganic composite layer is integrated with the active material layer, the organic-inorganic composite layer may need to have a desired or improved adhesion to the active material layer.

In examples, the nanofibers include a matrix, and the inorganic material is impregnated into the matrix.

The matrix includes one or more of a polyimide (PI)-based polymer and a polyamic acid (PAA)-based polymer. One or more of a polyimide-based polymer and a polyamic acid-based polymer may readily increase the dispersibility of one or more of boron nitride nanosheets and boron nitride nanotubes in nanofibers including one or more of boron nitride nanosheets and boron nitride nanotubes, increase adhesion to the active material layer and the puncture strength of the organic-inorganic composite layer, and further lower the heat shrinkage rate of the organic-inorganic composite layer. The above-described effects were achieved by producing nanofibers by including one or more of boron nitride nanosheets and boron nitride nanotubes in a matrix composed of or including one or more of a polyimide-based polymer and a polyamic acid-based polymer.

According to an example embodiment of the present disclosure, one or more of the polyimide-based polymer and the polyamic acid-based polymer may be included in the remaining amount of the nanofibers excluding the inorganic material, for example, in an amount in a range of about 90 wt % to about 99.9 wt % or 93 wt % to 99.9 wt %.

According to an example embodiment of the present disclosure, one or more of the polyimide-based polymer and the polyamic acid-based polymer may be included in the matrix in an amount in a range of about 95 wt % or more, for example, 99 wt % to 100 wt %, or 100 wt %.

According to an example embodiment of the present disclosure, the matrix may be composed of or include the polyimide-based polymer alone or the polyamic acid-based polymer alone.

According to another example embodiment of the present disclosure, the polymer matrix is composed of or includes a mixture of a polyimide-based polymer and a polyamic acid-based polymer, and based on 100 wt % of the mixture, the polyimide-based polymer: polyamic acid-based polymer ratio may be in a range of about 20 wt % to about 50 wt %: about 50 wt % to about 80 wt %, for example, 20 wt % to 40 wt %: 60 wt % to 80 wt %. Within the above range, compatibility between polyimide and polyamic acid in the polymer matrix may be desired or improved.

According to an example embodiment of the present disclosure, the polyimide-based polymer may include a repeating unit of Chemical Formula 1 below.

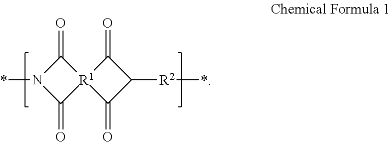

In Chemical Formula 1,
* refers to the connecting part of an element,
R¹ is or includes a tetravalent organic group, and
R² is or includes a divalent aliphatic, alicyclic, or aromatic organic group or a combination thereof, which has a total carbon number of 3 to 30.

In an example embodiment, R² of Chemical Formula 1 may be or include a C₃ to C₃₀ alkylene group, cycloalkylene group, or arylene group having at least a linking group such as or including at least one of —O—, —SO₂—, —CO—, —CH₂—, —C(CH₃)₂—, —OSi(CH₃)₂—, —C₂H₄O—, and —S—.

In an example embodiment, R¹ of Chemical Formula 1 may be or include at least one of moieties represented by chemical formulas below:

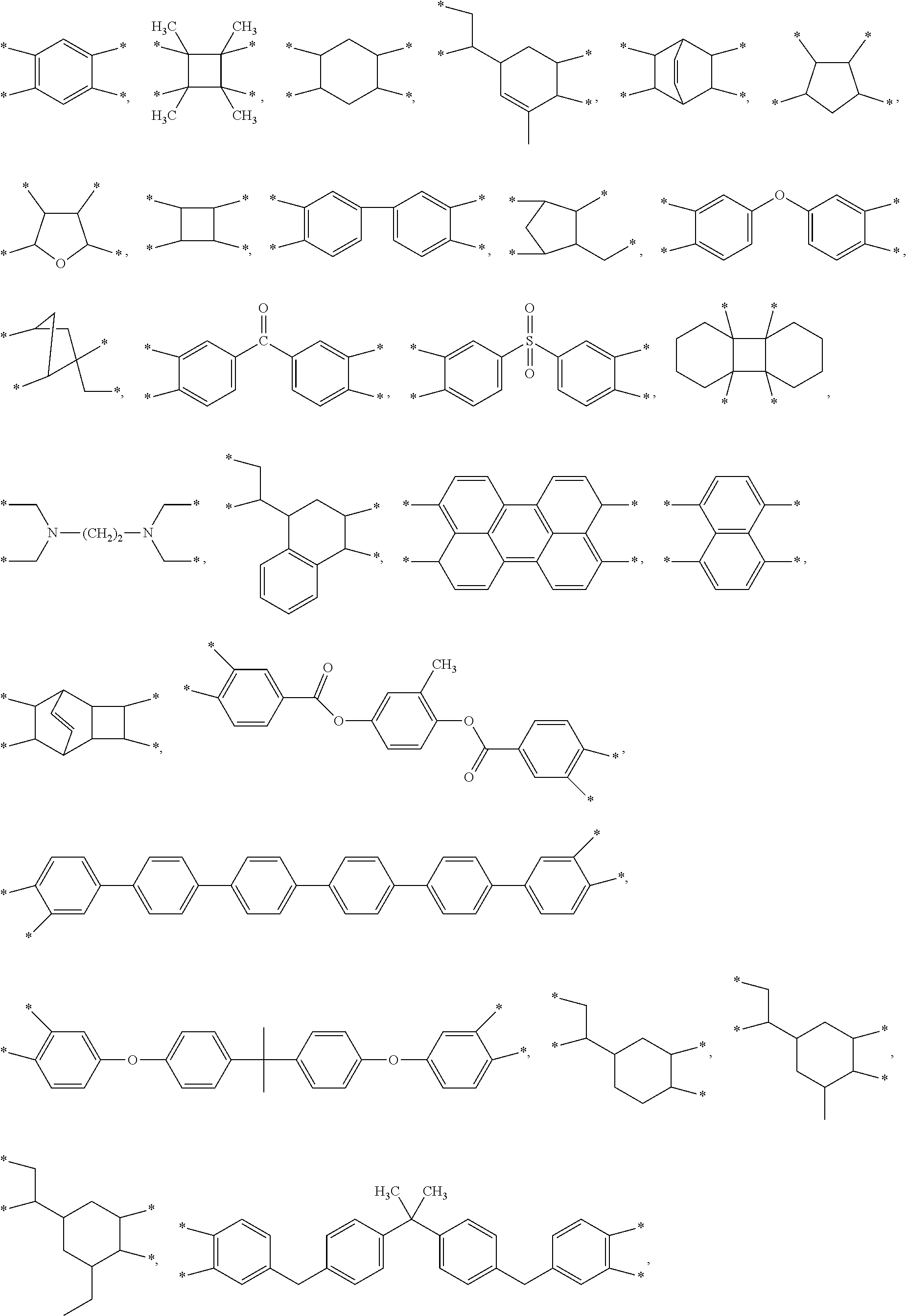

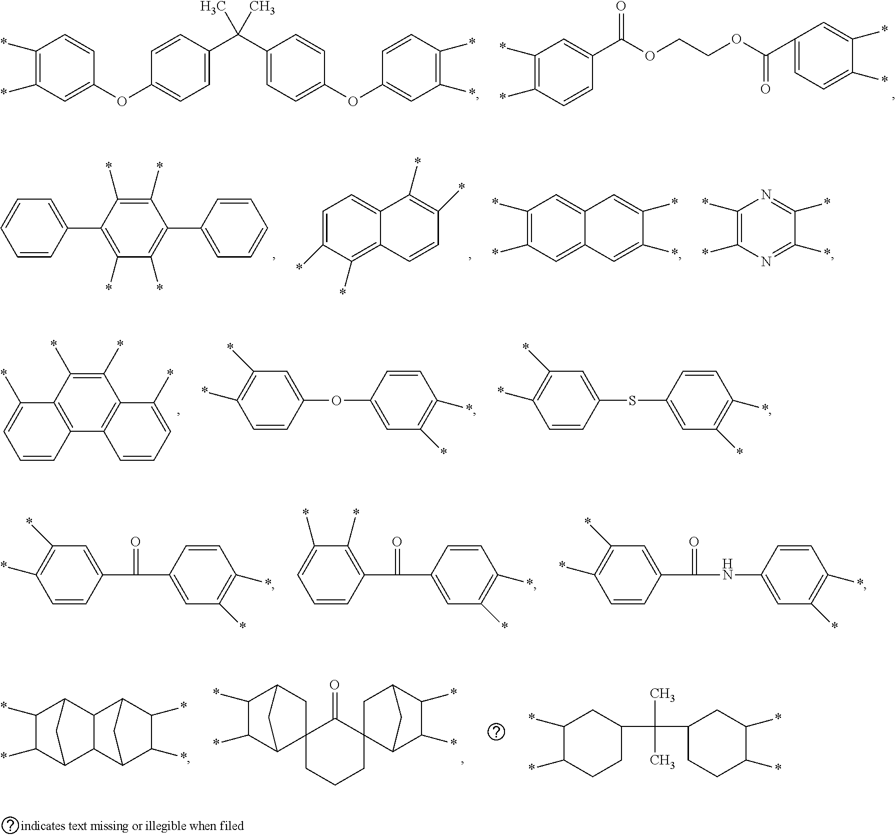

and * is the connecting part of an element.

The polyimide-based polymer may be manufactured by conventional methods known to those skilled in the art.

According to an example embodiment, the polyamic acid-based polymer may include one or more repeating units of Chemical Formula 2 and Chemical Formula 3 below:

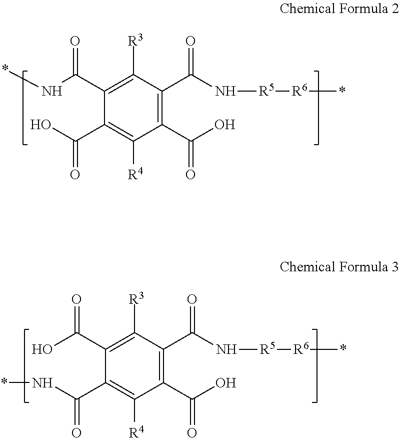

In Chemical Formula 2 and Chemical Formula 3,
* refers to the connecting part of an element,
R³ and R⁴ each independently is or includes hydrogen or a C₁ to C₅ alkyl group,
R⁵ is or includes a single bond, a C₁ to C₅ alkylene group, a C₆ to C₁₀ arylene group, or a C₇ to C₁₀ arylalkylene group, and
R⁶ is or includes a C₁ to C₅ alkylene group, a C₆ to C₁₀ arylene group, a C₇ to C₁₀ arylalkylene group, or a C₆ to C₁₀ aryl ether group.

For example, the polyamic acid-based polymer may include one or more units of Chemical Formulas 2-1 and 2-2 below:

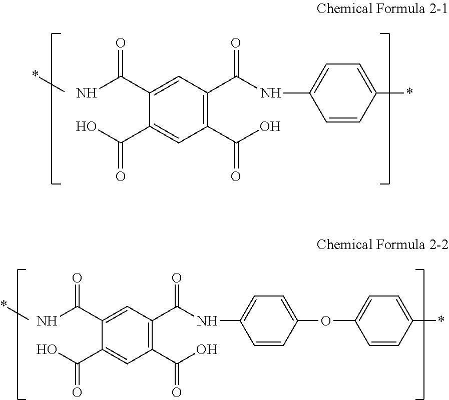

The polyamic acid-based polymer may be manufactured by conventional methods known to those skilled in the art.

Hereinafter, a method of manufacturing the organic-inorganic composite layer is described.

The manufacturing method includes preparing an electrospinning solution including one or more of a polyimide-based polymer and a polyamic acid-based polymer, and one or more of boron nitride nanosheets and boron nitride nanotubes, and forming an organic-inorganic composite layer by electrospinning the electrospinning solution onto one surface of the active material layer.

### (1) Preparing the Electrospinning Solution

An electrospinning solution, which includes one or more of a polyimide-based polymer and a polyamic acid-based polymer and one or more of boron nitride nanosheets and boron nitride nanotubes, is prepared. In the electrospinning solution, one or more of the boron nitride nanosheets and boron nitride nanotubes are included in an amount in a range of about 0.1 wt % to about 7 wt % based on solid content.

Because the electrospinning solution further includes a solvent, the dispersion of each component in the electrospinning solution may be improved. The solvent may be or include at least one of dimethyl acetate, methylformamide, dimethylacetamide, N-methylpyrrolidone, and the like, but is not limited thereto.

The total content of each component in the electrospinning solution may range from about 5 wt % to about 20 wt % based on 100 wt % of the total electrospinning solution. Within the above range, the organic-inorganic composite layer may be formed to an desired thickness.

When preparing the electrospinning solution, stirring may be additionally performed to increase the dispersion of one or more of the boron nitride nanosheets and boron nitride nanotubes. In the present disclosure, one or more of the boron nitride nanosheets and the boron nitride nanotubes may be readily dispersed without using ultrasonic waves. For example, by using ultrasonic waves, the boron nitride nanosheets and the boron nitride nanotubes may be sufficiently dispersed.

### (2) Forming an Organic-Inorganic Composite Layer by Electrospinning

The electrospinning process may be performed by disposing one nozzle pack composed of a tip with a hole size of 23 gauge (G) to 30 gauge (G) and a collecting roller at regular intervals, adding the electrospinning solution to the tip, placing the active material layer on the collecting roller, and then applying a voltage of 35 kV to 50 kV, for example, 40 to 50 kV, to the tip. The number of tips may be adjusted as desired depending on the content of one or more of the polyimide-based polymer and the polyamic acid-based polymer and the like in the electrospinning solution, and may range, for example, from about 20 to about 60. The distance between the nozzle pack and the active material layer may range from about 10 cm to about 20 cm. A hole size of the tip of 25 G to 30 G may be desired because an organic-inorganic composite layer may be formed in a desired shape.

According to the electrospinning process, the electrospinning solution is electrospun, stretched in the form of a fiber, and is spun onto the active material layer in a cone shape, thereby forming an organic-inorganic composite layer. For example, the electrospinning solution, which hangs as a droplet at the end of the tip due to surface tension, is distorted in the direction opposite to the surface tension of the solution when voltage is applied and charge repulsion occurs, and at the critical voltage, the polymer solution is sprayed from the tip of the droplet, and a jet, called a Taylor cone, is collected by a collecting roller and forms an organic-inorganic composite layer.

According to an example embodiment, the electrospinning process may be performed under the condition of a temperature in a range of about 20° C. to about 30° C. and a relative humidity in a range of about 40% to about 60%. When the electrospinning process is performed under the above temperature and relative humidity conditions, spinning may be performed while keeping the diameter of nanofibers constant.

The roll speed of the collecting roller may be adjusted so that the organic-inorganic composite layer can be formed to a desired thickness, and may be, for example, a speed ranging from about 1 m/min to about 3 m/min. In addition, the roll speed may be adjusted so that the solid content in the electrospinning solution is discharged from the tip at a rate in a range of about 20 μl/min to about 200 μl/min.

The tip air is adjusted as desired to minimize interference between tips so that electrospinning may be substantially uniformly performed. The tip air may be adjusted by flowing compressed air at a pressure in a range of about 0.1 MPa to about 0.2 MPa.

In an example embodiment, after performing the electrospinning process, drying may be performed at a temperature in a range of about 20° C. to about 30° C. In another example embodiment, after performing the electrospinning process, drying may be performed with hot air at a temperature in a range of about 70° C. to about 110° C.

### Active Material Layer for Rechargeable Lithium Battery:

The active material layer for a rechargeable lithium battery may be or include a positive electrode active material layer or a negative electrode active material layer. For example, the active material layer for a rechargeable lithium battery may be or include a negative electrode active material layer.

The positive electrode active material layer includes a positive electrode active material, and may further include a binder and/or a conductive material. For example, the positive electrode active material layer may further include an additive that may be configured as a sacrificial positive electrode.

The content of the positive electrode active material may range from about 90 wt % to about 99.5 wt % based on 100 wt % of the positive electrode active material layer, and the content of the binder and conductive material may each range from about 0.5 wt % to about 5 wt % based on 100 wt % of the positive electrode active material layer.

As a positive electrode active material, a compound capable of reversible intercalation and deintercalation of lithium (lithiated intercalation compound) may be included. For example, one or more of composite oxides of lithium and a metal such as or including at least one of cobalt, manganese, nickel, and combinations thereof may be included.

The composite oxide may be or include a lithium transition metal composite oxide, and examples include at least one of lithium nickel-based oxide, lithium cobalt-based oxide, lithium manganese-based oxide, lithium iron phosphate-based compound, cobalt-free nickel-manganese-based oxide, or a combination thereof.

As an example, a compound represented by any one of the following chemical formulas may be used: LiₐA_{1-b}X^{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O₂₋ₐDₐ (0.90≤a≤1.8, 0≤b≤0.5, 0≤c≤0.5, 0<α<2); LiₐNi_{1-b-c}Mn_{b}X_{c}O₂₋ₐDₐ (0.90≤a≤1.8, 0≤b≤0.5, 0≤c≤0.5, 0<α<2); LiₐNi_{b}Co_{c}L_{1d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂ (PO₄)₃ (0≤f≤2); and LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

As an example, the positive electrode active material may be a nickel-rich positive electrode active material having a nickel content of 80 mol % or more, 85 mol % or more, 90 mol % or more, 91 mol % or more, or 94 mol % or more and 99 mol % or less, based on 100 mol % of metals excluding lithium in the lithium transition metal composite oxide. The nickel-rich positive electrode active material may be applicable to a high capacity and high density rechargeable lithium battery due to the high capacity thereof.

The binder is configured to adhere the positive electrode active material particles to each other, or to adhere the positive electrode active material to the current collector. As a representative example, the binder may be or include at least one of polyvinyl alcohol, carboxymethyl cellulose, hydroxypropyl cellulose, diacetyl cellulose, polyvinyl chloride, carboxylated polyvinyl chloride, polyvinyl fluoride, and a polymer including ethylene oxide, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, nylon, and the like, but is not limited thereto.

The conductive material is included to impart conductivity to the electrode, and any electronically conductive material may be included as long as the electronically conductive material does not cause chemical changes in the battery. The conductive material may be or include, for example, carbon-based materials such as at least one of natural graphite, artificial graphite, carbon black, acetylene black, ketjen black, carbon fibers, carbon nanofibers, and carbon nanotubes, metallic substances including at least one of copper, nickel, aluminum, silver, and the like in the form of metal powder or metal fiber; conductive polymers such as polyphenylene derivatives; or a mixture thereof.

The negative electrode active material layer includes a negative electrode active material, and may further include a binder and/or a conductive material. For example, the negative electrode active material layer may include about 90 wt % to about 99 wt % of the negative electrode active material, about 0.5 wt % to about 5 wt % of the binder, and about 0 wt % to 5 about wt % of the conductive material.

The negative electrode active material includes at least one of a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions is or includes a carbon-based negative electrode active material, and may include, for example, crystalline carbon, amorphous carbon, or a combination thereof. Examples of the crystalline carbon may include graphite such as at least one of amorphous, plate-shaped, flaky, spherical or fibrous natural graphite or artificial graphite, and examples of the amorphous carbon may include at least one of soft carbon, hard carbon, mesophase pitch carbide, and calcined coke.

The alloy of the lithium metal may be or include an alloy of lithium with a metal such as or including at least one of Na, K, Rb, Cs, Fr, Be, Mg, Ca, Sr, Si, Sb, Pb, In, Zn, Ba, Ra, Ge, Al, and Sn.

An Si-based negative electrode active material or an Sn-based negative electrode active material may be included as a material capable of doping and dedoping lithium. The Si-based negative electrode active material may be or include at least one of silicon, a silicon-carbon composite, SiOₓ (0<x<2), or an Si-Q alloy (where Q is or includes at least one of an alkali metal, an alkaline earth metal, a group 13 element, a group 14 element (excluding Si), a group 15 element, a group 16 element, a transition metal, a rare earth element, and combinations thereof). The Sn-based negative electrode active material may be or include at least one of Sn, SnO₂, an Sn-based alloy, or a combination thereof.

The silicon-carbon composite may be or include a composite of silicon and amorphous carbon. According to an example embodiment, the silicon-carbon composite may be in the form in which silicon particles and the surface of the silicon particles are coated with amorphous carbon. For example, the silicon-carbon composite may include a secondary particle (core), in which silicon primary particles are assembled, and an amorphous carbon coating layer (shell) on the surface of the secondary particle. The amorphous carbon may also be located between the silicon primary particles, and the silicon primary particles may be, for example, coated with amorphous carbon. The secondary particles may be present in a dispersed state in an amorphous carbon matrix.

The silicon-carbon composite may further include crystalline carbon. For example, the silicon-carbon composite may include a core, which includes crystalline carbon and silicon particles, and an amorphous carbon coating layer on the surface of the core.

The Si-based negative electrode active material or Sn-based negative electrode active material may be included by mixing with a carbon-based negative electrode active material.

The binder is configured to adhere negative electrode active material particles to each other, or the negative electrode active material to the current collector. The binder may be or include at least one of a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and combinations thereof.

When an aqueous binder is included as the negative electrode binder, a cellulose-based compound capable of imparting viscosity may be further included. As the cellulose-based compound, a mixture of one or more types of carboxymethyl cellulose, hydroxypropylmethyl cellulose, methyl cellulose, or alkali metal salts thereof may be included. As the alkali metal, at least one of Na, K, or Li may be included.

The dry binder is or includes a polymer material capable of being fiberized, and may be or include, for example, at least one of polytetrafluoroethylene, polyvinylidene fluoride, a polyvinylidene fluoride-hexafluoropropylene copolymer, polyethylene oxide, or a combination thereof.

The conductive material is included to impart conductivity to the electrode, and any electronically conductive material may be included as long as the electronically conductive material does not cause chemical changes in the battery. Examples may include carbon-based materials such as or including at least one of natural graphite, artificial graphite, carbon black, acetylene black, ketjen black, carbon fibers, carbon nanofibers, carbon nanotubes, and the like, metallic substances including at least one of copper, nickel, aluminum, silver, and the like in the form of metal powder or metal fiber, conductive polymers such as polyphenylene derivatives, or a mixture thereof.

The electrode for a rechargeable lithium battery may further include a current collector.

The current collector may be located on one side of the active material layer. According to an example embodiment, the electrode may include the active material layer, a current collector located on one side of the active material layer, and an organic-inorganic composite layer located on the other side of the active material layer. According to an example embodiment, the organic-inorganic composite layer may be formed on the other side of the current collector.

The current collector for the positive electrode active material layer may include an aluminum current collector. The current collector for the negative electrode active material layer may be or include at least one of copper foil, nickel foil, stainless steel foil, titanium foil, nickel foam, copper foam, a polymer substrate coated with a conductive metal, and combinations thereof.

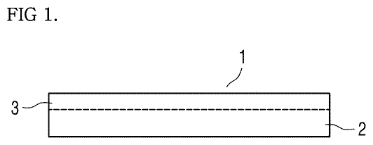

FIG. 1 is a cross-sectional view of the electrode, according to an example embodiment.

Referring to FIG. 1, the electrode 1 includes an active material layer 2 for a rechargeable lithium battery, and an organic-inorganic composite layer 3 integrated with the active material layer 2.

In FIG. 1, the active material layer 2 and the organic-inorganic composite layer 3 are depicted as being formed as separate layers, but this is intended to designate the active material layer 2 and the organic-inorganic composite layer 3. The dotted line indicates that the active material layer 2 and the organic-inorganic composite layer 3 are in fact integrated into one another.

Another example aspect of the present disclosure includes a rechargeable lithium battery including the electrode for a rechargeable lithium battery, and an electrode for a rechargeable lithium battery facing the electrode.

In the rechargeable lithium battery, the electrode for a rechargeable lithium battery has different electrical characteristics compared to the other electrode for a rechargeable lithium battery. In other words, when the electrode assembly for a rechargeable lithium battery includes a positive electrode for a rechargeable lithium battery, the electrode for a rechargeable lithium battery may be a negative electrode. In addition, when the electrode assembly for a rechargeable lithium battery includes a negative electrode for a rechargeable lithium battery, the electrode for a rechargeable lithium battery may be a positive electrode.

The rechargeable lithium battery may further include an electrolyte between the electrodes.

In examples, the electrolyte for a rechargeable lithium battery includes a non-aqueous organic solvent and a lithium salt.

The non-aqueous organic solvent is configured as a medium through which ions involved in the electrochemical reaction of the battery can move.

The non-aqueous organic solvent may be or include at least one of a carbonate-based, ester-based, ether-based, ketone-based, alcohol-based solvent, an aprotic solvent, or a combination thereof.

The carbonate-based solvent may include at least one of dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. The ketone-based solvent may include cyclohexanone, and the like. The alcohol-based solvent may include at least one of ethyl alcohol and isopropyl alcohol. The aprotic solvent may include at least one of nitriles such as R-CN (R is a C₂ to C₂₀ hydrocarbon group with a straight, branched, or ring structure, and may include a double bond, an aromatic ring, or an ether group), amides such as dimethylformamide, dioxolanes such as 1,3-dioxolane, 1,4-dioxolane, and the like, sulfolane, and the like.

The non-aqueous organic solvent may be included alone or in combination of two or more types of solvents.

When the carbonate-based solvent is included, a cyclic carbonate and a chain carbonate may be mixed, and the cyclic carbonate and chain carbonate may be mixed in a volume ratio in a range of about 1:1 to about 1:9.

The lithium salt is dissolved in an organic solvent and is configured as a source of lithium ions in the battery, enabling the basic operation of a rechargeable lithium battery, and promoting the movement of lithium ions between the positive and negative electrodes. Representative examples of lithium salts may include one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), LiC₄F₉SO₃, LiN(CₓF₂ₓ₊₁SO₂)(CyF_{2y+1}SO₂) (x and y are integers from 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into a cylindrical-type, a prismatic-type, a pouch-type, a coin-type, and the like, depending on its shape.

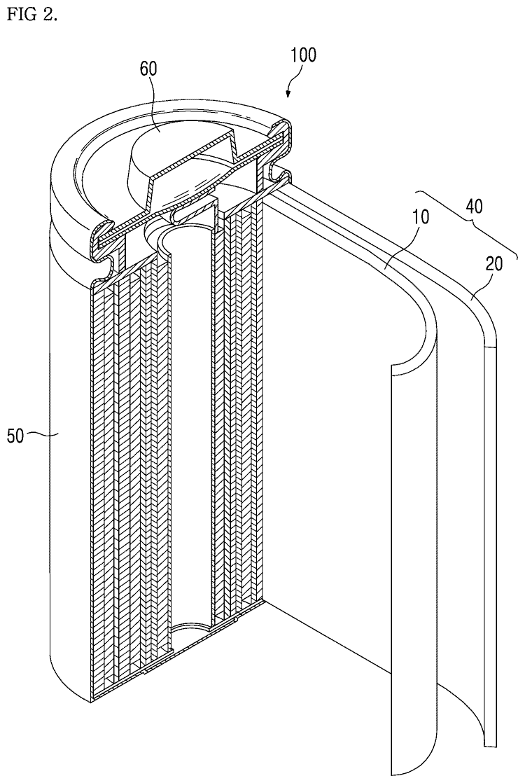

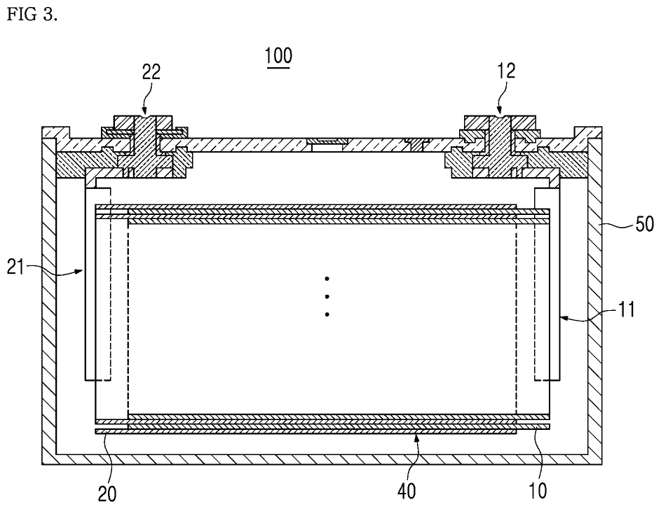

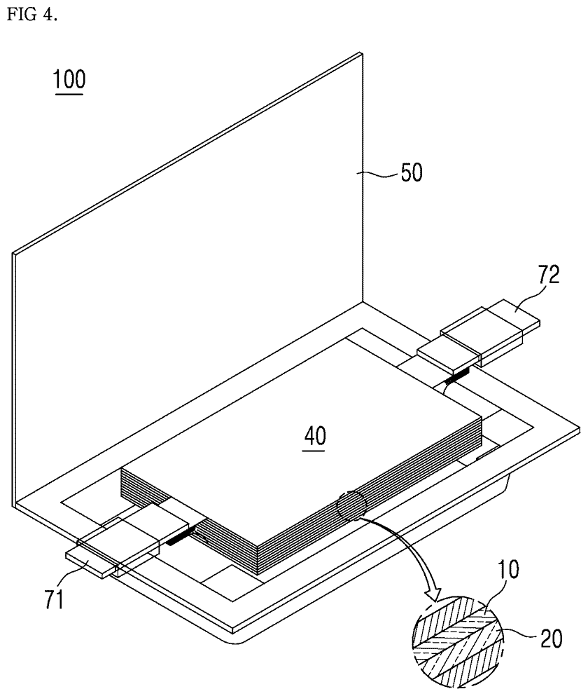

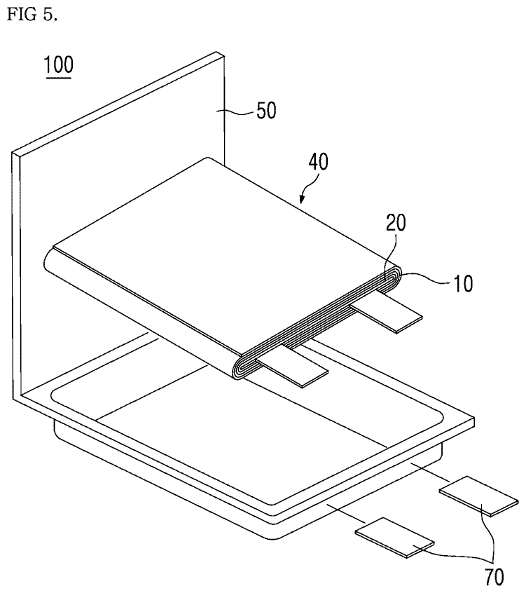

FIGS. 2 to 5 are schematic diagrams illustrating a rechargeable lithium battery, according to an example embodiment, where FIG. 2 is a schematic diagram of a cylindrical battery, FIG. 3 is a schematic diagram of a prismatic battery, and FIGS. 4 and 5 are schematic diagrams of pouch-type batteries.

Referring FIGS. 2 to 5, a rechargeable lithium battery 100 may include an electrode assembly 40, which includes a positive electrode 10 for a rechargeable lithium battery and a negative electrode 20 including a negative electrode active material layer for a rechargeable lithium battery and an organic layer, and a case 50, in which the electrode assembly 40 is accommodated. The positive electrode 10 and the negative electrode 20 may be impregnated with an electrolyte (not shown). The rechargeable lithium battery 100 may include a sealing member 60, which seals the case 50, as illustrated in FIG. 2. In addition, in FIG. 3, the rechargeable lithium battery 100 may include a positive electrode lead tab 11, a positive electrode terminal 12, a negative electrode lead tab 21, and a negative electrode terminal 22. As illustrated in FIGS. 4 and 5, the rechargeable lithium battery 100 may include electrode tabs 70 illustrated in FIG. 5, or a positive electrode tab 71 and a negative electrode tab 72 illustrated in FIG. 4, the electrode tabs 70/71/72 forming an electrical passage for inducing the current formed in the electrode assembly 40 to the outside of the battery 100.

The rechargeable lithium battery according to an example embodiment of the present disclosure may be applicable to, e.g., automobiles, mobile phones, and/or various types of electrical devices, but the present disclosure is not limited thereto.

Hereinafter, examples and comparative examples of the present disclosure are described. The following examples are only an example of the present disclosure, and the present disclosure is not limited thereto.

### Example 1

97.5 wt % of a mixture of artificial graphite and natural graphite, 1.0 wt % of carboxymethyl cellulose, and 1.5 wt % of styrene butadiene rubber (SBR) were mixed in water as a solvent to prepare a negative electrode active material slurry. The negative electrode active material slurry was applied on a copper current collector, dried, and rolled to manufacture a negative electrode active material layer.

A polyimide-based polymer (PI, P84, Evonik Industries AG), as a polymer, was added to dimethyl acetate, as a solvent, and dissolved at 70° C. to prepare a polyimide solution. Boron nitride nanosheets (BNNSs, thickness: 10 nm, maximum diameter: 0.1 μm), as an inorganic material, were added to dimethyl acetate, as a solvent, and dispersed by ultrasonic waves to prepare a boron nitride nanosheet solution. The prepared polyimide solution and the boron nitride nanosheet solution were mixed and stirred to prepare an electrospinning solution. The electrospinning solution was electrospun on the negative electrode active material layer and dried at 100° C. to form a layer (thickness: 10 μm) including nanofibers (including polyimide and boron nitride nanosheets, average diameter: 90 nm). The electrospinning process was carried out by the following method.

The electrospinning process was performed under the conditions of 26° C. and a relative humidity of 50% and carried out by disposing one nozzle pack composed of 52 tips with a hole size of 25 G and a collecting roller at intervals of 15 cm, adding the electrospinning solution to the tips, and applying a voltage of 40 to 50 kV. The roll speed of the collecting roller was set to 1 to 3 m/min, and the solid content in the electrospinning solution discharged from the tip was 150 μl/min.

Through the above process, a negative electrode in which the organic-inorganic composite layer (thickness: 10 μm) was integrated with the negative electrode active material layer was manufactured. In the nanofibers constituting the organic-inorganic composite layer, 1 wt % of boron nitride nanosheets was included.

96 wt % of LiCoO₂, 2 wt % of ketjen black, and 2 wt % of polyvinylidene fluoride were mixed in N-methylpyrrolidone as a solvent to prepare a positive electrode active material slurry. The positive electrode active material slurry was applied on an aluminum current collector, dried, and rolled to manufacture a positive electrode active material layer.

An electrode assembly was manufactured by stacking the negative electrode and the positive electrode in contact with each other. The organic-inorganic composite layer of the negative electrode and the positive electrode active material layer of the positive electrode were positioned in contact with each other. A rechargeable lithium battery (without a separator) was manufactured using the electrode assembly and an electrolyte. As the electrolyte, a mixed solvent of ethylene carbonate and ethyl methyl carbonate (50:50 volume ratio) in which LiPF₆ was dissolved, was included.

### Example 2

The same method as Example 1 was performed, with a difference that 3 wt % of boron nitride nanosheets were included in the nanofibers forming the organic-inorganic composite layer by changing the content of boron nitride nanosheets in the electrospinning solution.

### Example 3

The same method as Example 1 was performed, with a difference that 5 wt % of boron nitride nanosheets were included in the nanofibers forming the organic-inorganic composite layer by changing the content of boron nitride nanosheets in the electrospinning solution.

### Example 4

The same method as Example 1 was performed, with a difference that 7 wt % of boron nitride nanosheets were included in the nanofibers forming the organic-inorganic composite layer by changing the content of boron nitride nanosheets in the electrospinning solution.

### Example 5

The same method as Example 1 was performed, with a difference that 0.1 wt % of boron nitride nanosheets were included in the nanofibers forming the organic-inorganic composite layer by changing the content of boron nitride nanosheets in the electrospinning solution.

### Example 6

The same method as Example 1 was performed, with a difference that a polyamic acid-based polymer (PAA, including a repeating unit of the following Chemical Formula) was included instead of polyimide in the electrospinning solution.

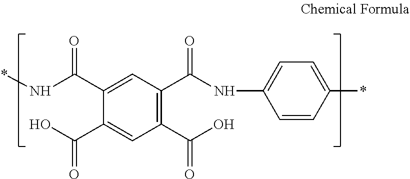

### Example 7

The same method as Example 1 was performed, with a difference that boron nitride nanotubes (BNNTs) were included instead of boron nitride nanosheets in the electrospinning solution.

### Comparative Example 1

The same method as Example 1 was performed, with a difference that boron nitride nanosheets were not included in the electrospinning solution.

### Comparative Example 2

The same method as Example 1 was performed, with a difference that a polypropylene-based separator was included between the positive electrode active material layer and the negative electrode active material layer instead of the organic-inorganic composite layer.

### Comparative Example 3

In Example 1, an electrospinning solution was prepared by changing the content of boron nitride nanosheets to 10 wt % in the electrospinning solution. However, an organic-inorganic composite layer could not be manufactured because electrospinning was not performed properly using the electrospinning solution.

### Comparative Examples 4 to 6

The same method as Example 1 was performed, with a difference that the components in Table 1 below were included as polymers instead of polyimide.

### Comparative Example 7

The same method as Example 1 was performed, with a difference that boehmite was included instead of the boron nitride nanosheets.

The following physical properties were evaluated for the negative electrodes including the organic-inorganic composite layers, prepared in Examples and Comparative Examples, and the batteries including the organic-inorganic composite layers, and the results thereof are illustrated in Table 1 below.

(1) Heat shrinkage rate (units: %): An organic-inorganic composite layer was prepared in the same manner as in Examples and Comparative Examples. The prepared organic-inorganic composite layer was cut into a size of 8 cm×8 cm to prepare a sample. After drawing a 5 cm×5 cm square on the surface of the sample, the sample was sandwiched between paper or alumina powder and left in an oven at 180° C. for 1 hour, and after taking out the sample, the dimensions of the sides of the square were measured, and the heat shrinkage rate in the machine direction (MD) and the transverse direction (TD) was calculated. The heat shrinkage rate was calculated according to Equation 1 below.

$$Heat shrinkage rate = ( L 0 - L 1 ) / L 0 \times 100 \qquad Equation 1$$

L0 is the initial length of the organic-inorganic composite layer, and L1 is the length of the organic layer after being left at 180° C. for 1 hour.

(2) Puncture strength (units: gf): After cutting the organic-inorganic composite layer into 50 mm width (MD)×50 mm length (TD) pieces at 10 different points to prepare 10 samples, the samples were placed on a 10 cm hole using a G5 device from Kato Tech Co., Ltd., and the piercing force was measured while pressing the samples with a 1 mm probe. After measuring the puncture strength of each sample three times, the average value was calculated.

TABLE 1

| | | Inorganic material | | Heat | |
|---|---|---|---|---|---|
| | | | Content | shrinkage | Puncture |
| | | | in | rate | strength |
| | Polymer | Types | nanofibers | (%) | (gf) |
| Example 1 | PI | BNNS | 1 | 0 | 94 |
| Example 2 | PI | BNNS | 3 | 0 | 137 |
| Example 3 | PI | BNNS | 5 | 0 | 205 |
| Example 4 | PI | BNNS | 7 | 0 | 371 |
| Example 5 | PI | BNNS | 0.1 | 0 | 75 |
| Example 6 | PAA | BNNS | 1 | 7 | 107 |
| Example 7 | PI | BNNT | 1 | 0 | 82 |
| Comparative | PI | BNNS | 0 | 0 | 58 |
| Example 1 | | | | | |
| Comparative | — | — | — | >50 | 350 |
| Example 2 | | | | | |
| Comparative | PI | BNNS | 10 | — | — |
| Example 3 | | | | | |
| Comparative | PVDF | BNNS | 1 | >50 | 168 |
| Example 4 | | | | | |
| Comparative | PAN | BNNS | 1 | 12 | 185 |
| Example 5 | | | | | |
| Comparative | PVDF/ | BNNS | 1 | 26 | 182 |
| Example 6 | PAN | | | | |
| Comparative | PI | Boehmite | 1 | 0 | 63 |
| Example 7 | | | | | |

*PI: Polyimide (P84, Evonik Industries AG)
*PAA: Poly(amic acid) 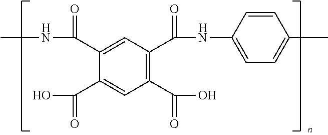
*PVDF: Polyvinylidene fluoride (Kynar 761A, Arkema S.A.)
*PAN: Polyacrylonitrile (from Polysciences, Inc. and including the unit of the following Chemical Formula) 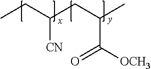
*In Comparative Example 6, the PVDF:PAN weight ratio was 1:1.

As shown in Table 1, the organic-inorganic composite layer of Examples had a desired or improved puncture strength and a low heat shrinkage rate.

Although the example embodiments of the present disclosure were described above, the present disclosure is not limited thereto, and it is possible to implement various modifications within the scope of the claims, the detailed description of the present disclosure, and the attached drawings, which naturally falls within the scope of the present disclosure.

What is claimed is:

1. An electrode for a rechargeable lithium battery, the electrode comprising:
an active material layer for a rechargeable lithium battery; and
an organic-inorganic composite layer integrated with the active material layer,
wherein the organic-inorganic composite layer includes nanofibers,
the nanofibers include an inorganic material and a matrix,
the inorganic material includes one or more of boron nitride nanosheets and boron nitride nanotubes,
the matrix includes one or more of a polyimide-based polymer and a polyamic acid-based polymer, and
the inorganic material is included in an amount in a range of about 0.1 wt % to about 7 wt % in the nanofibers.

2. The electrode of claim 1, wherein one or more of the boron nitride nanosheets and the boron nitride nanotubes are included in an amount in a range of about 95 wt % or more in the inorganic material.

3. The electrode of claim 1, wherein the boron nitride nanosheets have a thickness in a range of about 0.3 nm to about 10 nm, and a maximum diameter in a range of about 10 nm to about 200 nm.

4. The electrode of claim 1, wherein the boron nitride nanotubes have an average outer diameter in a range of about 10 nm to about 100 nm, and an average length in a range of about 1 μm to about 50 μm.

5. The electrode of claim 1, wherein one or more of the boron nitride nanosheets and the boron nitride nanotubes are impregnated in the matrix.

6. The electrode of claim 1, wherein the polyimide-based polymer comprises a repeating unit of Chemical Formula 1: 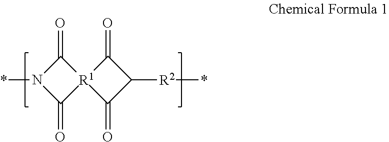
in Chemical Formula 1,
* refers to the connecting part of an element,
R¹ comprises a tetravalent organic group, and
R² comprises a divalent aliphatic, alicyclic, or aromatic organic group or a combination thereof, which has a total carbon number of 3 to 30.

7. The electrode of claim 1, wherein the polyamic acid-based polymer comprises one or more units of Chemical Formula 2 and Chemical Formula 3: 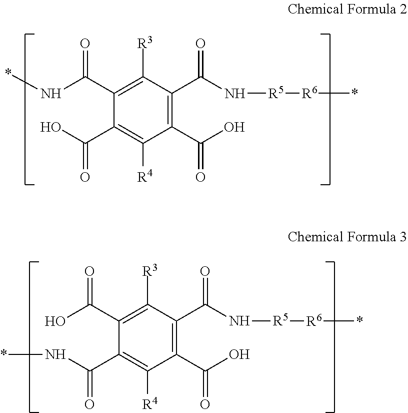
in Chemical Formula 2 and Chemical Formula 3,
* refers to the connecting part of an element,
R³ and R⁴ each independently comprises hydrogen or a C₁ to C₅ alkyl group,
R⁵ comprises a single bond, a C₁ to C₅ alkylene group, a C₆ to C₁₀ arylene group, or a C₇ to C₁₀ arylalkylene group, and
R⁶ comprises a C₁ to C₅ alkylene group, a C₆ to C₁₀ arylene group, a C₇ to C₁₀ arylalkylene group, or a C₆ to C₁₀ aryl ether group.

8. The electrode of claim 1, wherein one or more of the polyimide-based polymer and the polyamic acid-based polymer are included in an amount in a range of about 95 wt % or more in the matrix.

9. The electrode of claim 1, wherein the organic-inorganic composite layer is in a woven or non-woven nanofiber state.

10. The electrode of claim 1, wherein the organic-inorganic composite layer comprises a single layer.

11. The electrode of claim 1, wherein the organic-inorganic composite layer comprises a porous layer.

12. The electrode of claim 1, wherein the active material layer comprises a negative electrode active material layer.

13. The electrode of claim 12, wherein the negative electrode active material layer comprises:
about 90 wt % to about 99 wt % of a negative electrode active material,
about 0.5 wt % to about 5 wt % of a binder, and
about 0 wt % to about 5 wt % of a conductive material.

14. A rechargeable lithium battery comprising:
the electrode for a rechargeable lithium battery of claim 1; and
a second electrode for a rechargeable lithium battery facing the electrode for a rechargeable lithium battery.

15. The battery of claim 14, wherein the rechargeable lithium battery does not have a separator.
